(19) United States
(12) Patent Application Publication
(10) Pub. No.: US 2012/0013550 A1
(43) Pub. Date: Jan. 19, 2012

(54) METHOD FOR CONTROLLING THE INTERACTIONS OF A USER WITH A GIVEN ZONE OF A TOUCH SCREEN PANEL

(76) Inventors: Jean-Baptiste MARTINOLI, St-Anaclet-de-Lessard (CA); Jacques Desplat, Lyon (FR)

(21) Appl. No.: 13/007,127

(22) Filed: Jan. 14, 2011

Related U.S. Application Data
(60) Provisional application No. 61/365,021, filed on Jul. 16, 2010.

(51) Int. Cl. G06F 3/041

(52) U.S. Cl. 345/173

(57) ABSTRACT

A method for controlling interactions of a user with a given zone of a touch screen panel is disclosed, the method comprises detecting a signal indicative of a request to control interactions with a given zone of the touch screen panel; displaying on the touch screen panel a window covering the given zone of the touch screen panel and disabling possible interactions of the user with the given zone of the touch screen panel when said window is covering the given zone, wherein said user may selectively toggle between covering and uncovering said given zone using said window using a predetermined gesture.

### CROSS-REFERENCE AND RELATED APPLICATIONS

The application claims priority of U.S. Provisional patent application No. 61/365,021 entitled “Method for controlling the interactions of a user with a given zone of a touch screen panel” that was filed on Jul. 16, 2010, the specification of which is hereby incorporated by reference.

### FIELD OF THE INVENTION

The invention relates to the field of computing devices. More precisely, this invention pertains to a method for controlling the interactions of a user with a given zone of a touch screen panel.

### BACKGROUND

There exist today various types of input devices for interacting with a computer device.

In computing devices equipped with a touch screen panel, the touch screen panel itself is used for interacting with the computer device.

This increases the interactivity with the user but this may also be a source of nuisance and unwanted actions causing distractions to the user. By only touching the touch screen panel, a user may launch an undesired application which is a drawback.

While in many cases the launching of an application may be a nuisance, in other instances the intempestive launching of an application may have serious consequences which is a drawback.

There is a need for a method for method for controlling the interactions of a user that will overcome at least one of the above-identified drawbacks.

Features of the invention will be apparent from review of the disclosure, drawings and description of the invention below.

### BRIEF SUMMARY

The invention provides a method for controlling the interactions of a user with a given zone of a touch screen panel, the method comprises detecting a signal indicative of a request to control interactions with a given zone of the touch screen panel, displaying on the touch screen panel a window covering the given zone of the touch screen panel and disabling possible interactions of the user with the given zone of the touch screen panel when said window is covering the given zone, wherein said user may selectively toggle between covering and uncovering said given zone using said window using a predetermined gesture.

According to one embodiment, there is provided a method for controlling the interactions of a user with a given zone of a touch screen panel, the method comprising detecting a signal indicative of a request to control interactions with a given zone of the touch screen panel; displaying on the touch screen panel a window covering the given zone of the touch screen panel and disabling possible interactions of the user with the given zone of the touch screen panel when the window is covering the given zone; wherein the user may selectively toggle between covering and uncovering the given zone using the window using a predetermined gesture.

In one embodiment, the signal indicative of a request to control interactions with a given zone of the touch screen panel is provided by a user.

In another embodiment, the signal indicative of a request to control interactions with a given zone of the touch screen panel is provided by an application.

In yet another embodiment, the signal indicative of a request to control interactions with a given zone of the touch screen panel is provided by an application when at least one given condition is met.

In yet another embodiment, the at least one given condition comprises execution of a task.

In yet another embodiment, the given zone comprises a single icon displayed on the touch screen panel.

In accordance with one embodiment, the given zone comprises a plurality of icons displayed on the touch screen panel.

In yet another embodiment, the window covering the given zone of the touch screen panel has a translucent aspect.

In yet another embodiment, the predetermined gesture comprises a sliding motion.

In yet another embodiment, the sliding motion is performed by a user using a finger motion.

In another embodiment, the sliding motion is performed by the user on the window.

In accordance with another embodiment, there is provided a computer-readable storage medium storing computer-executable instructions which, when executed, cause a computing device comprising a touch screen panel to perform a method for controlling the interactions of a user with a given zone of the touch screen panel, the method comprising detecting a signal indicative of a request to control interactions with a given zone of the touch screen panel; displaying on the touch screen panel a window covering the given zone of the touch screen panel and disabling possible interactions of the user with the given zone of the touch screen panel when the window is covering the given zone; wherein the user may selectively toggle between covering and uncovering the given zone using the window using a predetermined gesture.

In accordance with another embodiment, there is provided a computing device, comprising a touch screen panel; one or more central processing units; a memory comprising an application; and one or more programs, wherein the one or more programs are stored in the memory and configured to be executed by the one or more central processing units, the one or more programs including instructions for detecting a signal indicative of a request to control interactions with a given zone of the touch screen panel; instructions for displaying on the touch screen panel a window covering the given zone of the touch screen panel and instructions for disabling possible interactions of the user with the given zone of the touch screen panel when the window is covering the given zone; wherein the user may selectively toggle between covering and uncovering said given zone using said window using a predetermined gesture.

### BRIEF DESCRIPTION OF THE DRAWINGS

In order that the invention may be readily understood, embodiments of the invention are illustrated by way of example in the accompanying drawings.

FIG. 1 is a block diagram which shows an embodiment of a computing device in which an embodiment of a method for controlling interactions of a user with a given zone of a touch screen panel may be implemented;

FIG. 2 is a flowchart which shows an embodiment of a method for controlling interactions of a user with a given zone of a touch screen panel; according to a first processing step a signal indicative of a request to control interactions is detected; according to a second processing step a window covering the given zone is displayed and according to a third processing step possible interactions of the user with the given zone are disabled;

FIG. 3 is a diagram which shows an embodiment of a graphics user interface in which an embodiment of the method for controlling interactions of a user with a given zone of a touch screen panel may be implemented;

FIG. 4 is an enlarged view of one part of the graphics user interface; and

FIG. 5 is a flowchart which shows an embodiment of a method for enabling possible interactions of the user with the given zone.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

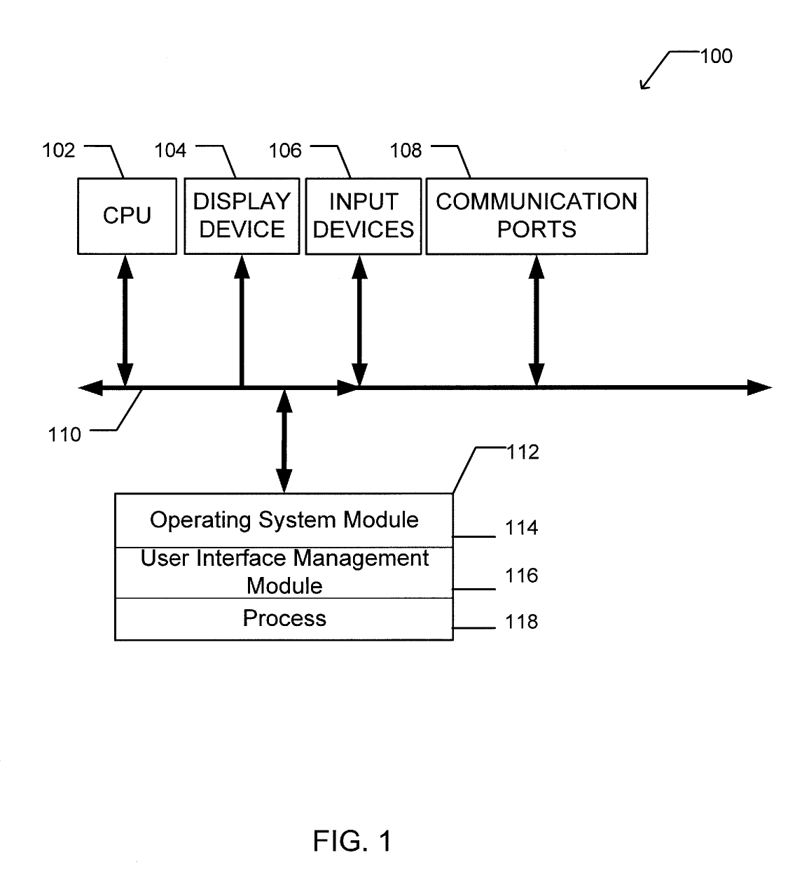

Now referring to FIG. 1, there is shown an embodiment of a computing device 100 in which an embodiment of a method for controlling interactions of a user with a given zone of a touch screen panel may be implemented.

In this embodiment the computing device 100 comprises one or more Central Processing Unit (CPU) 102, a display device 104, input devices 106, communication ports 108, a data bus 110 and a memory 112.

The one or more Central Processing Unit 102, the display device 104, the input devices 106, the communication ports 108 and the memory 112 are connected together using the data bus 110.

In one embodiment the computing device 100 is the ExoPC™ manufactured by Pegatron. Still in this embodiment the Central Processing Unit 102 is Atom Pineview-M N450 manufactured by Intel™, running at 1.66 GHz and supporting 64 bits.

Still in this embodiment, the display device 104 comprises a touch screen panel having 11.6-inch width and a resolution of 1366×768 pixels with 135 pixels per inch. The touch screen panel uses a multipoint capacitive technology known to the ones skilled in the art. The display device 104 further comprises a GMA500 graphics card manufactured by Intel™.

The input devices 106 are used for providing data to the computing device 100.

In this embodiment, the input devices 106 comprise an accelerometer, a microphone, a luminosity sensor and a camera. The skilled addressee will appreciate that various other embodiments for the input devices 106 may alternatively be provided.

The communications ports 108 are used for enabling a communication of the computing device 100 with other devices.

In this embodiment, the communication ports 108 comprise a WIFI 802.11 b/g/n port, a Bluetooth 2.1+EDR port, two USB 2.0 ports, a SD/SDHC card reader and a mini HDMI port. The skilled addressee will again appreciate that various other embodiments may be provided for the communication ports 108.

The memory 112 is used to store data.

In this embodiment, the memory 112 comprises a Solid State Drive (SSD) having a capacity of either 32 or 64 GB.

More precisely and still in this embodiment, the memory 112 comprises, inter alia, an operating system module 114. The operating system module 114 is Windows 7™ Home Premium Edition manufactured by Microsoft™.

The memory 112 further comprises a user interface management module 116. The user interface management module 116 is used to manage the user interface of the computing device 100. It will be appreciated that the method for controlling interactions of a user with a given zone of a touch screen panel may be implemented within the user interface management module 116. In such embodiment the user interface management module 116 may comprise instructions for detecting a signal indicative of a request to control interactions with a given zone of the touch screen panel; instructions for displaying on the touch screen panel a window covering the given zone of the touch screen panel and instructions for disabling possible interactions of the user with the given zone of the touch screen panel when the window is covering the given zone; wherein the user may selectively toggle between covering and uncovering said given zone using the window using a predetermined gesture.

It will be appreciated by the skilled addressee that alternative embodiments may be possible. For instance, the method for controlling the interactions of a user with a given zone of a touch screen panel may be implemented within the operating system module 114.

The memory 112 further comprises a process 118. It will be appreciated that the process 118 may be of various types. For instance the process may be an application.

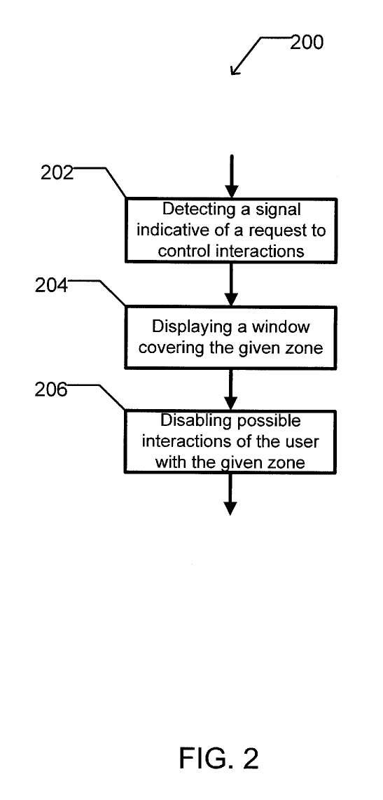

Now referring to FIG. 2, there is shown an embodiment of a method for controlling interactions of a user with a given zone of a touch screen panel.

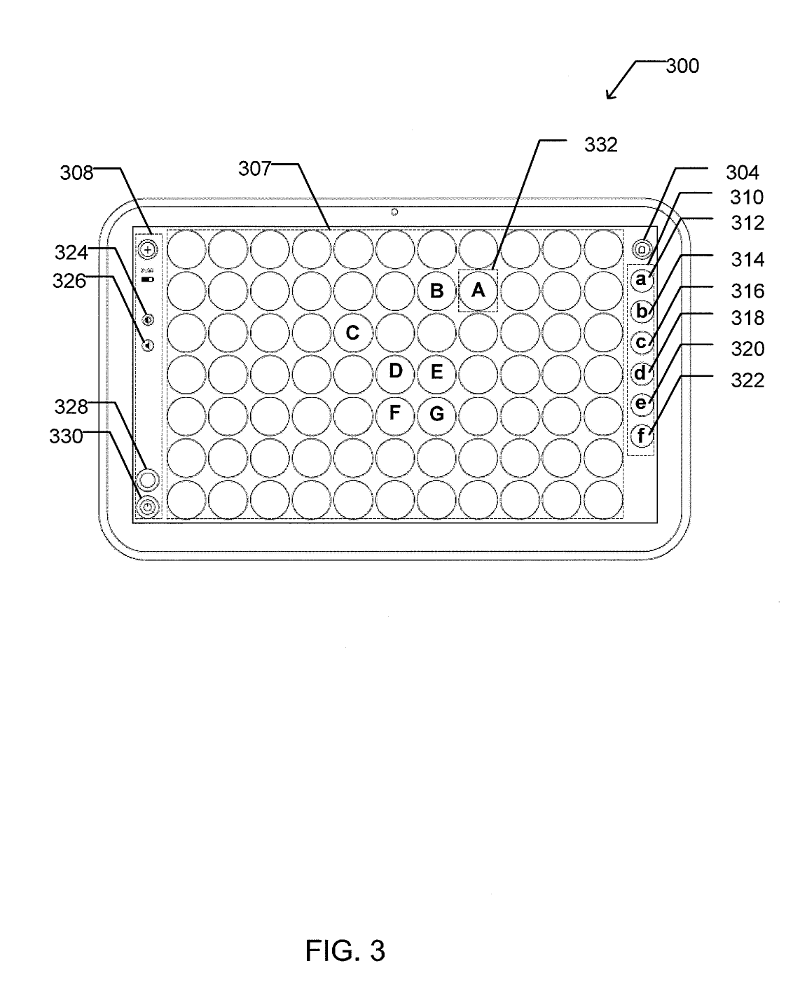

Now referring to FIG. 3, there is shown an example of a graphics user interface 300 in which the method for controlling interactions of a user with a given zone of a touch screen panel may be implemented.

The graphics user interface 300 comprises a left hand portion 308, a central portion 307 and a right hand portion comprising a home button 304 and a display application portion 310.

The left hand portion 308 comprises a plurality of icons each used for a specific function. For instance and in the embodiment shown in FIG. 3, icon 324 is used for adjusting luminosity and contrast, icon 326 is used for controlling the volume of the sound output, icon 328 is used for starting a menu and icon 330 is used for starting/stopping the computing device 100.

The central portion 307 is used for displaying a plurality of applications installed in the computing device 100. In the embodiment shown in FIG. 3, applications A, B, C, D, E, F and G are available. For instance, application A can be launched by touching icon 332.

It will be appreciated that each of the available circles can host an icon representative of an application available for execution. Moreover, it will be appreciated that a background image, not shown, may be provided in background of the plurality of circles. In an alternative embodiment, geometric shapes other than a circle may be used for receiving icons representative of an application.

The right hand portion comprises a home button 304 for accessing a home menu comprising all the icons of available applications.

The display application portion 310 comprises a plurality of icons representative of applications that are currently being executed.

For instance, icon 312 is representative of application A that is being currently executed, icon 314 is representative of application B that is being currently executed, icon 316 is representative of application C that is being currently executed, icon 318 is representative of application D that is being currently executed, icon 320 is representative of application E that is being currently executed and icon 322 is representative of application F that is being currently executed.

The skilled addressee will appreciate that it is possible to access a given application being executed by touching the icon representative of the application sought. For instance, a user can access application F by touching icon 322.

A user may therefore easily toggle between applications using the display application portion 310.

Now referring back to FIG. 2 and according to processing step 202, a signal indicative of a request to control interactions with at least one part of the graphics user interface 300 is detected.

It will be appreciated that the signal indicative of a request to control interactions may be of various types and may be provided in various ways.

In one embodiment the signal may be provided by a user. Alternatively, the signal may be provided by an application when at least one given condition is met. This may be the case when an application performs a given task. In the case where the application is a movie player, this may happen when a user starts watching a movie.

In a preferred embodiment, the signal is provided by an application when it is executed.

According to processing step 204, a window covering the given zone is displayed.

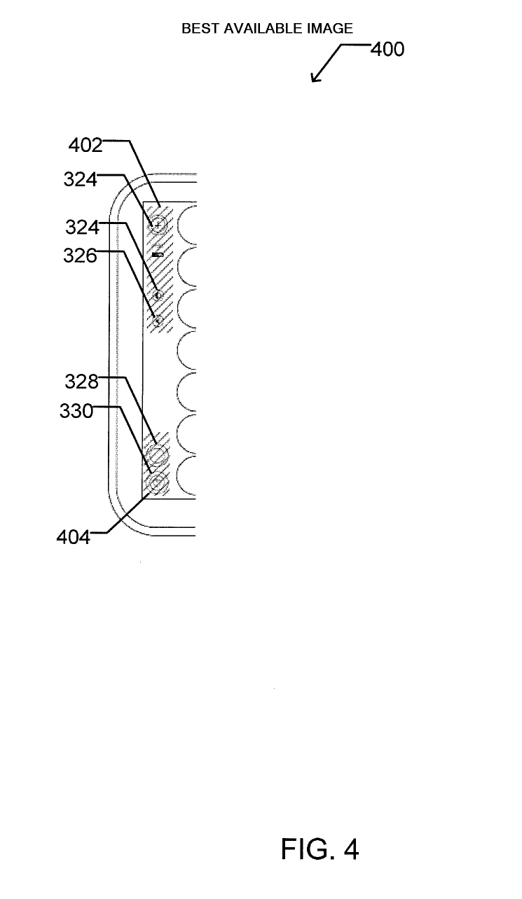

Now referring to FIG. 4, there is shown an embodiment of at least one part of the graphics user interface 300 wherein a given zone has been covered.

More precisely and in this embodiment icons located in the left hand portion 324 have been covered by a first window 402 and a second window 404.

The skilled addressee will appreciate that in one embodiment the given zone may comprise a single icon. In an alternative embodiment the given zone may comprise a plurality of icons. Still in another embodiment, the given zone may cover other objects than icons.

The skilled addressee will further appreciate that the given zone is not limited by any shape or form.

In a preferred embodiment, the given zone has a circular shape matching shape of an icon.

Moreover, the window covering the given zone may have any visual aspect such as a translucent aspect in one embodiment.

In a preferred embodiment the window covering the given zone has a circular shape.

Referring back to FIG. 2 and according to processing step 206, possible interactions of the user with the given zone are disabled.

It will be appreciated that the possible interactions of the users with the given zone are disabled as long as the window is covering the given zone in one embodiment.

In a preferred embodiment, processing step 206 is implemented by the superimposing of the window on the given zone. Under the Microsoft™ Windows™ environment, such superimposing allows the disabling of any interactions with the given zone. Various alternative embodiments may be possible.

In an alternative embodiment, the possible interactions of the users with the given zone are disabled for a given amount of time.

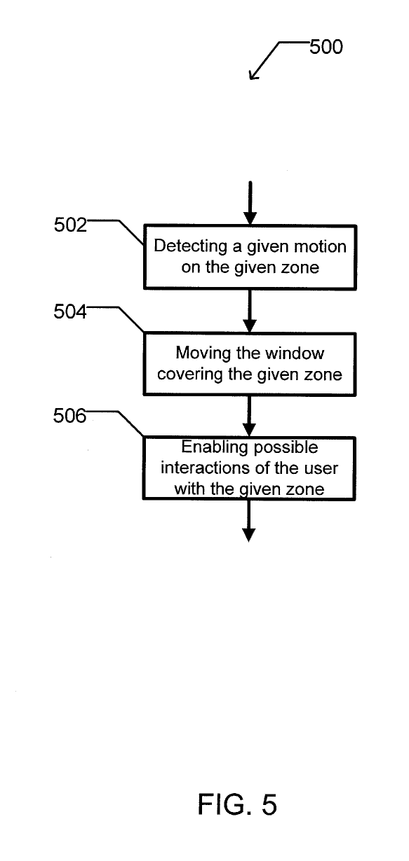

Now referring to FIG. 5, there is shown an embodiment of a method for enabling possible interactions of the user with the given zone.

According to processing step 502, a given motion is detected on the given zone.

It will be appreciated by the skilled addressee that the given motion may be of any type. In one embodiment the given motion comprises a predetermined gesture.

In a preferred embodiment, the given motion comprises a sliding motion performed by a user using a finger on the window covering the given zone.

According to processing step 504, a window covering the given zone is moving.

In a preferred embodiment, the window covering the given zone is moving according to the sliding motion.

According to processing step 506, possible interactions of the user with the given zone are enabled.

The skilled addressee will appreciate that the user may therefore selectively toggle between covering and uncovering the given zone using the window using a predetermined gesture which is of great interest.

It will be appreciated that the method disclosed herein may be implemented according to various embodiments and using various programming languages known to the skilled addressee.

Also, it will be appreciated that a computer-readable storage medium may be provided for storing computer-executable instructions. Such computer-executable instructions would cause a computing device comprising a touch screen panel, when executed, to perform a method for controlling the interactions of a user with a given zone of the touch screen panel, the method comprising detecting a signal indicative of a request to control interactions with a given zone of the touch screen panel; displaying on the touch screen panel a window covering the given zone of the touch screen panel and disabling possible interactions of the user with the given zone of the touch screen panel when said window is covering the given zone; wherein said user may selectively toggle between covering and uncovering said given zone using said window using a predetermined gesture.

Although the above description relates to a specific preferred embodiment as presently contemplated by the inventors, it will be understood that the invention in its broad aspect includes functional equivalents of the elements described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for controlling the interactions of a user with a given zone of a touch screen panel, the method comprising:
detecting a signal indicative of a request to control interactions with a given zone of the touch screen panel;
displaying on the touch screen panel a window covering the given zone of the touch screen panel; and
disabling possible interactions of the user with the given zone of the touch screen panel when said window is covering the given zone;
wherein said user may selectively toggle between covering and uncovering said given zone using said window using a predetermined gesture.

2. The method as claimed in claim 1, wherein the signal indicative of a request to control interactions with a given zone of the touch screen panel is provided by a user.

3. The method as claimed in claim 1, wherein the signal indicative of a request to control interactions with a given zone of the touch screen panel is provided by an application.

4. The method as claimed in claim 3, wherein said signal indicative of a request to control interactions with a given zone of the touch screen panel is provided by an application when at least one given condition is met.

5. The method as claimed in claim 4, wherein the at least one given condition comprises execution of a task.

6. The method as claimed in claim 1, wherein the given zone comprises a single icon displayed on the touch screen panel.

7. The method as claimed in claim 1, wherein the given zone comprises a plurality of icons displayed on the touch screen panel.

8. The method as claimed in claim 1, wherein the window covering the given zone of the touch screen panel has a translucent aspect.

9. The method as claimed in claim 1, wherein the predetermined gesture comprises a sliding motion.

10. The method as claimed in claim 1, wherein the sliding motion is performed by a user using a finger motion.

11. The method as claimed in claim 10, wherein the sliding motion is performed by the user on the window.

12. A computer-readable storage medium storing computer-executable instructions which, when executed, cause a computing device comprising a touch screen panel to perform a method for controlling the interactions of a user with a given zone of the touch screen panel, the method comprising:
detecting a signal indicative of a request to control interactions with a given zone of the touch screen panel;
displaying on the touch screen panel a window covering the given zone of the touch screen panel; and
disabling possible interactions of the user with the given zone of the touch screen panel when said window is covering the given zone;
wherein said user may selectively toggle between covering and uncovering said given zone using said window using a predetermined gesture.

13. A computing device, comprising:
a touch screen panel;
one or more central processing units;
a memory comprising an application; and
one or more programs, wherein the one or more programs are stored in the memory and configured to be executed by the one or more central processing units, the one or more programs including:
instructions for detecting a signal indicative of a request to control interactions with a given zone of the touch screen panel;
instructions for displaying on the touch screen panel a window covering the given zone of the touch screen panel; and
instructions for disabling possible interactions of the user with the given zone of the touch screen panel when said window is covering the given zone;
wherein said user may selectively toggle between covering and uncovering said given zone using said window using a predetermined gesture.
